(19) United States
(12) Patent Application Publication
(10) Pub. No.: US 2025/0249589 A1
(43) Pub. Date: Aug. 7, 2025

(54) SYSTEMS AND METHODS FOR TELEOPERATED ROBOT

(71) Applicant: Nimble Robotics, Inc., San Francisco, CA (US)

(72) Inventors: Simon Kalouche, San Francisco, CA (US); Aditya Agarwal, San Francisco, CA (US); Gen Xu, South San Francisco, CA (US); Aleksi Hämäläinen, San Francisco, CA (US); Rohan Tiwari, San Francisco, CA (US); Siva Mynepalli, San Francisco, CA (US); Suyash Nigam, San Francisco, CA (US)

(73) Assignee: Nimble Robotics, Inc., San Francisco, CA (US)

(21) Appl. No.: 19/186,088

(22) Filed: Apr. 22, 2025

Related U.S. Application Data
(63) Continuation of application No. 17/480,653, filed on Sep. 21, 2021.

(51) Int. Cl. B25J 9/16; B25J 19/02

(52) U.S. Cl. CPC B25J 9/1689; B25J 9/161; B25J 9/1687; B25J 19/023

(57) ABSTRACT

The technology is directed to providing pick and place instructions to a robot. Sensor data including an image feed of a picking container in which at least one product is located may be output. An input indicating a selected product including at least one of the products located in the picking container may be received. A representation of the selected product and at least one image of the order container may be output for display. The representation of the product may be scaled relative to the at least one image of the order container. A place input corresponding to the position of the representation of the product at a packing location within the at least one image of the order container may be received and transmitted to a robot control system.

### CROSS-REFERENCE TO RELATED APPLICATION

This application is a continuation of U.S. patent application Ser. No. 17/480,653, filed on Sep. 21, 2021, the disclosures of which are incorporated herein by reference.

### BACKGROUND

Order fulfillment is the procedure in which orders are processed, picked from storage systems, packed, and shipped to the customer. Some fulfillment centers or warehouses rely on autonomous robots to complete one or more order fulfillment tasks to reduce delivery times.

Autonomous robots can generally perform repetitive tasks (e.g., tasks with little variation) with greater accuracy and efficiency than human workers. On the other hand, robots are not currently adept at autonomously performing tasks in unstructured, dynamic environments that require substantial variation, such as handling millions of different objects with varying sizes, dimensions, shapes, weights, and stiffness. When a robot is instructed to perform a series of picking and packing tasks, the robot may occasionally encounter an edge case scenario in which the robot cannot autonomously complete the task. For example, the robot may be incapable of securely grasping the item and moving it from the picking location to a desired order container. In situations in which the robot is unable to complete the task, a warehouse worker may need to physic ally perform the desired task on behalf of the robot before the robot can return to autonomous operation. In other instances, the warehouse worker, or another operator, can teleoperate or pilot the robot to assist the robot in performing the assigned tasks.

Despite the recent improvements to teleoperation systems, draw backs remain. For example, teleoperator systems typically require an operator to take complete control of the robot and to manually guide the robot throughout the entire task. Such manual efforts are duplicative of the efforts previously undertaken by the robot and result in inefficiencies. Moreover, current teleoperator systems provide limited functionality, which may prevent a teleoperator from leveraging the full capabilities of the robot. By way of example, current teleoperator systems often only instruct a robot as to which order container to place a picked item but are not typically capable of instructing the robot to place the item within the desired order container in a specific orientation or location within the order container. Worker intervention is thus required to avoid packing inefficiencies (e.g., using boxes that are larger than necessary, more boxes than necessary to ship items, or insecurely packaging the items) and, in turn, the higher shipping costs associated therewith.

### BRIEF SUMMARY

In accordance with a first aspect of the present disclosure, a system including a teleoperator interface is provided. Among other advantages, the interface is designed to allow an operator to efficiently instruct a robot to pick an item from a picking location and to pack the item in a particular location and orientation within a storage container. As a result, the operator can instruct a robot to densely pack and rearrange items within an order container, reducing or otherwise negating the need f or worker intervention to minimize packing inefficiencies. Moreover, the teleoperator interface provides the ability for an operator to request the assistance of an onsite worker when such assistance is required.

One embodiment is directed to a method for providing pick and place instructions to a robot. The method may include outputting, by the one or more processors, sensor data, the sensor data including an image feed of a picking container in which at least one product is located; receiving, by the one or more processors, an input indicating a selected product, the selected product being one of the at least one products located in the picking container; outputting for display, by the one or more processors, a representation of the selected product and at least one image of the order container, the representation of the product being scaled relative to the at least one image of the order container; receiving, by the one or more processors, a place input, the place input corresponding to positioning the representation of the product at a packing location within the at least one image of the order container; transmitting, by the one or more processors, the packing location to a robot control system.

Another aspect of the disclosure is directed to a system for providing pick and place instructions to a robot. The system may include one or more processors and memory storing instructions. The instructions, when executed by the one or more processors, cause the one or more processors to: output sensor data, the sensor data including an image feed of a picking container in which at least one product is located; receive an input indicating a selected product, the selected product being one of the at least one products located in the picking container; output for display, a representation of the selected product and at least one image of the order container, the representation of the product being scaled relative to the at least one image of the order container; receive a place input, the place input corresponding to positioning the representation of the product at a packing location within the at least one image of the order container; and transmit the packing location to a robot control system.

Another aspect of the disclosure is directed to a non-transitory, tangible computer-readable storage medium on which computer-readable instructions of a program are stored, the instructions, when executed by one or more computing devices, cause the one or more computing devices to perform a method. The method may include outputting sensor data, the sensor data including an image feed of a picking container in which at least one product is located; receiving an input indicating a selected product, the selected product being one of the at least one products located in the picking container; outputting for display, a representation of the selected product and at least one image of the order container, the representation of the product being scaled relative to the at least one image of the order container; receiving, a place input, the place input corresponding to positioning the representation of the product at a packing location within the at least one image of the order container; transmitting, the packing location to a robot control system.

In some examples, an assistance request is received to assist a robot with completing a pick and place task, the pick and place task including moving the selected product from the picking container to the order container.

In some instances a user input is received, including a collection of point selections on the selected product.

In some instances, pixels corresponding to the selected product may be determined and the determined pixels may be provided to a control system. Determining the pixels may include determining the area within the collection of point selections.

In some instances, an instance segmentation mask is overlaid on the selected product in the image feed. In some examples, determining pixels corresponding to the selected product includes determining pixels covered by the instance segmentation mask.

In some instances, a user input is received to move the representation of the selected product from a first orientation to a second orientation within the packing location.

In some instances, at least one image of the order container is a red-green-blue (RGB) image.

### BRIEF DESCRIPTION OF THE DRAWINGS

Various embodiments of the present disclosure are described herein with reference to the drawings. The figures depict embodiments of the present disclosure for purposes of illustration only. Alternative embodiments of the structures and methods illustrated herein may be implemented without departing from the principles or benefits of the disclosure as described herein.

FIG. 1 is an example system including a robot in accordance with embodiments of the disclosure.

FIG. 2 is an illustration of an example robot in accordance with embodiments of the disclosure

FIG. 3 is a flow chart illustrating the operation of a system in accordance with aspects of the disclosure.

FIG. 4 is a flow chart illustrating an assistance process performed by a system during teleoperation of a robot in accordance with aspects of the disclosure.

FIGS. 5A-5G illustrate an example operation of a teleoperator interface for instructing a robot in accordance with aspects of the disclosure.

FIG. 6 illustrates an example operation of selecting a product in accordance with aspects of the disclosure.

### DETAILED DESCRIPTION

The technology disclosed herein relates to assisting robots in completing tasks. For example, a robot may autonomously attempt to complete a task, such as a pick and place instruction provided by a robot control system or determined by the robot based on a task received from the warehouse software. Before or during the autonomous attempt, the robot or the robot control system may determine that the robot is unlikely or unable to complete the task autonomously. In such instances, the robot control system may request assistance from an operator. Depending upon the type of assistance requested, the robot control system may request teleoperator assistance or onsite assistance.

In instances where teleoperator assistance is requested, an onsite operator, or a remote operator (collectively referred to herein as “a teleoperator”) may pilot instructions to the robot using a teleoperator system. The piloted instruction may fully control movements of the robot via inputs to the teleoperator system that are passed to the robot control system, which in turn, may send instructions to the robot to perform actions that are consistent with the inputs provided by the teleoperator. In some instances, the teleoperator may provide the robot control system with instructions for completing the task, such as instructing the location in which a product should be picked from and/or placed. In this scenario, the teleoperator does not maintain full control over the robot. Rather, the teleoperator provides few instructions to the robot to enable the robot to autonomously complete the task using the few instructions. The systems and techniques described herein provide teleoperators with the ability to more accurately and densely pack products within order containers. Moreover, the few high-level instructions provided by teleoperator may avoid or otherwise minimize latency as a robot completes a task. In this regard, the robot does not require consistent control from a teleoperator and may continue to operate autonomously after completing the few instructions provided by the teleoperator.

After receiving a request for teleoperator assistance from a robot control system, a teleoperator may determine that the assistance required by the robot would be better performed or can only be performed by an onsite operator. In the event that the teleoperator determines onsite physical assistance would be more efficient, the teleoperator may then request onsite assistance to assist the robot in performing a task. In such situations, the teleoperator system may provide a teleoperator with the option to request onsite assistance and, in some instances, may provide a description of the type of assistance that is requested.

When onsite assistance is requested, either from the robot or a teleoperator, the onsite operator may physically assist the robot with the task by manually performing or assisting the robot with the task.

In some instances, onsite operators and teleoperators may monitor the operation of robots and provide assistance before a request for assistance is received from a robot. For example, a teleoperator may receive an image or a video feed from a robot and determine that the robot will not be able to complete a task. Instead of waiting for the robot to request help, the teleoperator may, through the teleoperator system, preemptively assist the robot or request that assistance be provided by an onsite operator. Similar preemptive action may be taken by the onsite operator.

Although the foregoing examples describe the robot requesting help before or during an attempt to complete a task, the robot may request help when it needs or will need maintenance or when it encounters system failures or other obstacles or impediments. For example, a component of the robot, such as an arm or camera, may fail. Upon detecting such a failure, the robot may request teleoperation assistance or onsite assistance via the network. In another example, the robot may encounter an object blocking the path the robot needs to traverse to complete a task. Upon encountering such a situation, the robot may request onsite assistance to remove the object.

As used herein, the term “container” encompasses bins, totes, cartons, boxes, bags, auto-baggers, conveyors, sorters, containers, tables, platforms, other surfaces with or without sidewalls, and other such places or surfaces a product could be picked from or placed. To distinguish between containers from which products are to be picked and containers in which picked products are to be placed, the term “picking container” will be used to identify containers from where products are to be picked, and the term “order container” will be used to identify containers in which products are to be placed. In some instances, the picking container and the order container may be the same container. In such instances the container may be a partitioned or un-partitioned container. Also, as used herein, the terms “substantially,” “generally,” and “about” are intended to mean that slight deviations from absolute are included within the scope of the term so modified.

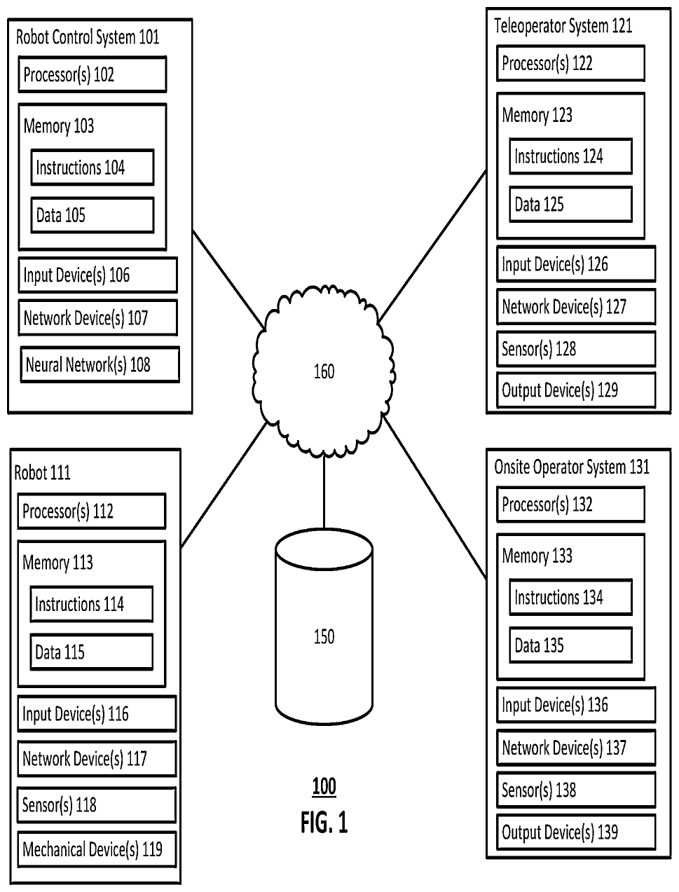

FIG. 1 illustrates a block diagram of a system 100 encompassing a robot control system 101, robot 111, and teleoperator system 121. System 100 may also include onsite operator system 131. Each of the systems, including the robot control system 101, robot 111, teleoperator system, and onsite operator system 131 are connected via a network 160. The system 100 may also include a storage device 150 that may be connected to the systems via network 160, as further shown in FIG. 1.

Although only one robot control system 101, one robot 111, one teleoperator system 121, one onsite operator system 131, and one storage device 150 are shown in FIG. 1, system 100 may include any number of system and storage devices, as the number of robot control systems, robots, teleoperator systems, onsite operator systems, and storage devices can be increased or decreased. For instance, the system 100 may include hundreds of robots and a few robot control systems for controlling the robots, as described herein. The system 100 may also include a plurality of teleoperator and onsite operator systems to assist, monitor, or otherwise control the robots. Accordingly, any mention of a teleoperator system, robot control system, an onsite operator system, or storage device may refer to any number of teleoperator systems, robot control systems, onsite operator systems, or storage devices.

Some embodiments of the system 100 may have different components than those described herein. For instance, some embodiments of the system 100 may include only an onsite operator system 131 but not a teleoperator system 121 or a teleoperator system 121 but not an onsite operator system 131. Similarly, some or all functions of some of the systems and storage devices may be distributed among the other systems. For example, the functions of the teleoperator system 121 may be performed by the onsite operator system 131. In another example, the functions of the robot control system 101 may be performed by robot 111, teleoperator system 121, and/or onsite operator system 131.

Robot control system 101 includes one or more processors 102, memory 103, one or more input devices 106, one or more network devices 107, and one or more neural networks 108. The processor 102 may be a commercially available central processing unit (“CPU”), a System on a Chip (“SOC”), an application-specific integrated circuit (“ASIC”), a microprocessor, microcontroller, or other such hardware-based processors. In some instances, robot control system 101 may include multiple processor types.

Memory, such as memory 103, may be configured to read, write, and store instructions 104 and data 105. Memory 103 may be any solid-state or other such non-transitory type memory device. For example, memory 103 may include one or more of a hard drive, a solid-state hard drive, NAND memory, flash memory, ROM, EEPROM, RAM, DVD, Blu-ray, CD-ROM, write-capable, and read-only memories, or any other device capable of storing data. Data 105 may be retrieved, manipulated, and/or stored by the processor 102 in the memory 103.

Data 105 may include data objects and/or programs or other such instructions, executable by the processor 102. Data objects may include data received from one or more components, such as other systems, processor 102, input device 106, network device 107, data storage 150, etc. The programs can be any computer or machine code capable of being executed by a processor, such as processor 102, including the vision and object detection algorithms described herein. The instructions 104 can be stored in any format for processing by a processor or in any other computing device language, including scripts or modules. The functions, methods, routines, etc., of the programs for vision and object detection algorithms, are explained in more detail herein. As used herein, the terms “instructions,” “applications,” “steps,” “routines,” and “programs” may be used interchangeably.

The robot control system 101 may include at least one network device 107. The network device 107 may be configured to communicatively couple robot control system 101 with the other systems, such as teleoperator system 121 or robot 111, or onsite operator system 131, and storage device 150 via the network 160. In this regard, the network device 107 may be configured to enable the robot control system 101 to communicate and receive data, such as data received from robot 111, and other such signals to other computing devices, such as teleoperator system 121 and onsite operator system 131, or data store 150. The network device 107 may include a network interface card (NIC), Wi-Fi card, Bluetooth receiver/transmitter, or other such device capable of communicating data over a network via one or more communication protocols, such as point-to-point communication (e.g., direct communication between two devices), Ethernet, Wi-Fi, HTTP, Bluetooth, LTE, 3G, 4G, Edge, etc., and various combinations of the foregoing.

Robot control system 101 may include one or more input devices 106 for interacting with the robot control system, robot 111 or other systems, such as teleoperator system 121 and onsite operator system 131. Input devices 106 may include components normally used in connection with a computing device such as keyboards, mice, touch screen displays, monitors, controllers, joysticks and the like.

The robot control system 101 may exchange data 105 via an internal bus (not shown), network device 107, direct connections, or other such connections. In this regard, data 105 may be exchanged between the memory 103, data storage device 150, processor 102, input device 106, and other systems, such as robot 111, teleoperator system 121, and onsite operator system 131.

Network 160 may include interconnected protocols and systems. The network 160 described herein can be implemented using various protocols and systems, such that the network can be part of the Internet, World Wide Web, specific intranets, wide area networks, or local networks. The network can utilize standard communications protocols, such as Ethernet, Wi-Fi and HTTP, proprietary protocols, and various combinations of the foregoing.

In some instances, the robot control system 101 may be connected to or include one or more data storage devices, such as storage device 150. Data storage device 150 may be one or more of a hard drive, a solid-state hard drive, NAND memory, ROM, RAM, DVD, CD-ROM, write-capable, and read-only memories, or any other device capable of storing data. The data storage device 150 may store data, including programs and data objects such as vision and object detection algorithms. Moreover, storage device 150 may store log data, such as information related to the performance of robots, completed tasks, assistance request history, etc. Although FIG. 1 illustrates data storage device 150 attached to a network 160, any number of data storage devices may be connected directly to the robot systems, including the robot control system 101, robot 111, teleoperator system 121, and onsite operator system 131.

References to a processor, computer, or robot will be understood to include references to a collection of processors, computers, robots that may or may not operate in parallel and/or in coordination. Furthermore, although the components of robot control system 101 are shown as being within the same block in FIG. 1, any combination of components of the robot control system may be located in separate housings and/or at different locations. For instance, robot control system may be a collection of computers, laptops, and/or servers distributed among many locations.

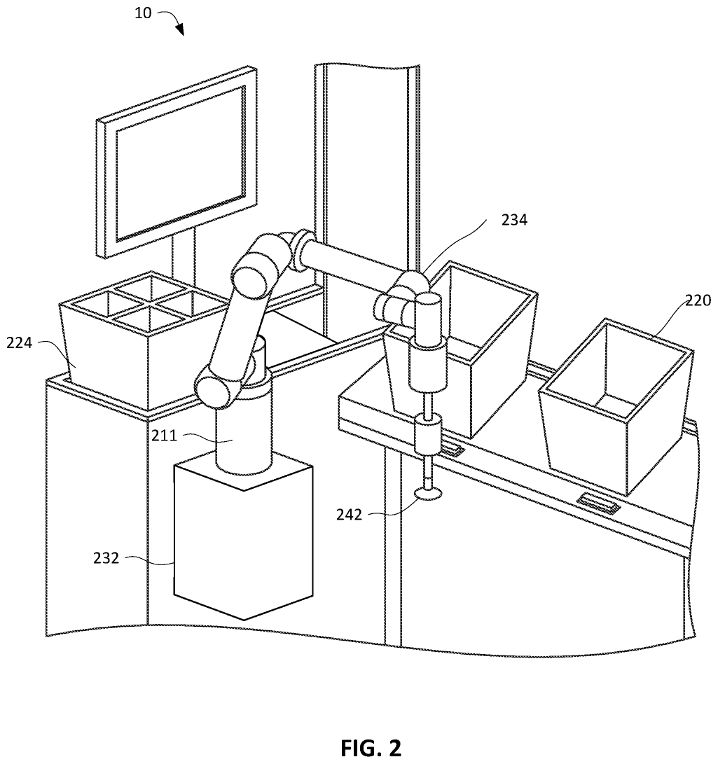

Robot 111 may be a stationary or mobile manipulator robot (sometimes referred to herein as “manipulator robot” or “robot”) that may perform tasks such as moving, picking and/or placing items within a warehouse or fulfillment center (hereinafter simply “warehouse”). An example of a stationary pick and place robot 211 within a warehouse 10 is shown in FIG. 2. Robot 211 may include a base 232 and a picking arm 234 with an end effector 242 for manipulating and grasping products. Picking arm 234 is positionable to allow end effector 242 to reach into picking container 224 and grasp the instructed item(s), and then move to place the grasped item(s) in the desired order bin 220. Although only one picking arm 234 and one end effector 242 are shown, robot 211 may include any number of picking arms and end effectors. Further, robot 211 may be capable of swapping one end effector of a first size and shape for another end effector of another type, configuration, size and/or shape. Although robot 211 is shown as being stationary, robot 211 may alternatively be mobile. Robot 111 may include other types of pick and place robots, such as those described in U.S. Pat. Pub, No. 2021/0032034, incorporated herein by reference in its entirety.

Robot 111 may operate in one of two modes: an autonomous mode, by executing autonomous control instructions, or a teleoperated mode, in which the control instructions are manually piloted (e.g., directly controlled) by a teleoperator, such as a remote teleoperator (e.g., a teleoperator located outside of the warehouse 10) or onsite teleoperator (e.g., a teleoperator located within the warehouse 10). While the term “control instructions,” whether autonomous or piloted, is primarily described herein as instructions for grasping and/or packing an item, it will be appreciated that the term may additionally refer to a variety of other robotic tasks such as the recognition of an inventory item, the swapping of one end effector for another end effector, inventory counting, doubles or multi-item-pick detection, damaged item detection, empty bin detection, inventory mismatch detection, inventory counting, edge case identification, or any other robotic task that facilitates the manipulation of objects or the environment to assist in order fulfillment tasks, manufacturing tasks, assembly tasks, or other tasks. In one embodiment, robot 111 may be a machine learning robot capable of executing autonomous or piloted control instructions.

Each robot 111 may include one or more processors 112, memory 113 storing instructions 114 and data 115, input devices 116, network devices 117, sensors 118, and mechanical devices 119. The processors 112, memory 113, input devices 116, and network devices 117 may be similar to processors 102, memory 103, input devices 106, and network devices 107 of the robot control system 101. The mechanical devices 119 may include components of the robot, such as the wheels, picking arm, and end effectors, etc.

As used herein, sensors 118 may include one or more image/video capture cards, cameras, including red-green-blue (RGB) or RGB-depth (D) cameras, video recorders, Light Detection and Ranging (LIDAR), sonar radar, accelerometers, depth sensors, etc. Such sensors may capture data in the environment surrounding the robot and/or information about the robot itself. The sensors 118 may be mounted to or within the robot 111. Such sensors 118 may also be mounted in the vicinity of the robot 111.

Robot 111 may send and/or receive processor-readable data or processor-executable instructions via communication channels, such as via network 160, to the robot control system 101. In this manner, the robot control system 101 can predict grasping poses (e.g., position and/or orientation and/or posture of the robotic picking arm) and send control instructions to robot 111 to execute the predicted grasping pose to autonomously grasp the product.

Although robot 111 and robot control system 101 are illustrated as separated devices in FIG. 1, a robot control system can be integrated into a robot. In this regard, a robot may perform all of the functions described herein as being performed by the robot control system. [

System 100 may further include one or more operator devices, including a teleoperator system 121 and an onsite operator system 131. Teleoperator system 121 may be positioned within the warehouse in which the robots 111 are located or external to the warehouse, whereas onsite operator system 131 is positioned in the warehouse, such as in the vicinity of the robots 111. Each operator system, including teleoperator system 121 and onsite operator system 131 may include one or more processors 122,132; memory 123,133 storing instructions 124, 134 and data 125,135; network devices 127,137; and sensors 128,138; which may be similar to processors 102, memory 103, and network devices 107 of the robot control system 101, respectively. Sensors 128,138 may be similar to sensors 118 of robot 111.

Teleoperator system and onsite operator system 121 and 131 may be personal computers, tablets, smartphones, wearable computers, or other such computing devices. Each of the operator systems may also include one or more input devices 126, 136 to capture control instructions from a remote operator and onsite operator, respectively. The one or more user input devices 126, 136 may be, for example, keyboards, mice, touch screen displays, displays, controllers, buttons, joysticks, and the like.

A teleoperator may input synchronous (real-time) or asynchronous (scheduled or queued) control instructions to the teleoperator system 121. The control instructions may be, for example, click point control instructions, 3d mouse control instructions, click and drag control instructions, keyboard or arrow key control instructions, text or verbal instructions, action primitive instructions, including high-level instructions for which the low-level instructions can be generated and performed by the teleoperator system 121 or other system, such as robot 111 or robot control system 101 system (e.g., instructions to place an item into a container, open a drawer, twist a knob, press a button, grab a tool, flick a switch, pick up an item, fold an item, wipe a table, move to another room, etc.) or other such instructions. In some instances, sensors 128 may function as input devices, such as by capturing hand or body control instructions.

Each of the operator systems may also include one or more output devices 129, 139. Output devices may include displays, head-mounted displays, such as smart glasses, speakers, and/or haptic feedback controllers (e.g., vibration element, piezoelectric actuator, rumble, kinesthetic, rumble motor). In some embodiments, the output device and input devices of the operator systems may be the same device. For instance, the input and output devices of the teleoperator system 121 may be a touchscreen.

Teleoperator system 121 may be utilized by teleoperators, to monitor, control, and or assist the operation of robots 111. In this regard, teleoperators may view or see sensor data, such as imagery provided by robot sensors 118. These images may include one or more still and/or moving images (e.g., videos) of the robot and/or its environment, such as picking containers and order containers, as well as the products contained therein. These videos may be replayed and/or viewed in real-time. If robot 111 is unsuccessful at autonomously performing the task, the operators can utilize teleoperator system 121 to instruct the robot to grasp a product and/or release the product with a specific orientation and into a specific location of the order container. By providing teleoperation capabilities via the teleoperator system 121, certain edge case scenarios can be corrected by the teleoperator.

Other edge case scenarios may be unable to be corrected via teleoperation and/or cannot be corrected in an efficient manner via teleoperation. In these situations, onsite operator system 131 may provide an onsite operator with a notification that their assistance is required to handle these edge cases. As described herein, these notifications may be provided by teleoperator system 121, robot control system 101, and/or robot 111. By providing onsite operators with assistance notifications via the onsite operator system 131, efficient handling for such cases edge cases is possible. For example, an onsite operator system 131 may be provided with a notification when maintenance issues with a robot, such as an arm, wheel, or camera failure, are encountered. In another example, onsite operator system 131 may receive a notification that an object is blocking the path that a robot needs to traverse to complete a task and that the object needs to be cleared. In yet another example, the onsite operator system 131 may receive a notification that a robot needs assistance with inventory that has fallen outside the reach of the robot.

Although teleoperator system 121 is primarily described herein in connection with assisting robot 111 in performing failed picking and packing tasks, it will be appreciated that teleoperator system 121 may be used at any time (including prior to a failed attempt) to allow a teleoperator to manually control or otherwise assist the robot in performing any manipulation task including the picking, rearranging, packing or repackaging of one or more items, picking up dropped items, manipulating items in container or any other order fulfillment tasks including the performance of inventory audits, replenishment tasks, system inspections, product identification and/or to override other autonomous control instructions. In some embodiments, onsite operator system 131 may also provide similar pick and place capabilities as those described herein with regard to the teleoperator system 121.

Although the components of system 100, including robot control system 101, teleoperator system 121, and onsite operator system 131 are primarily described herein as assisting robot 111 with completing pick and place tasks, the components of system 100 may be used to perform other tasks, as described in greater detail herein.

In addition to the operations described above and illustrated in the figures, various operations will now be described. The following operations do not have to be performed in the precise order described below. Rather, various steps can be handled in a different order or simultaneously, and steps may also be added or omitted.

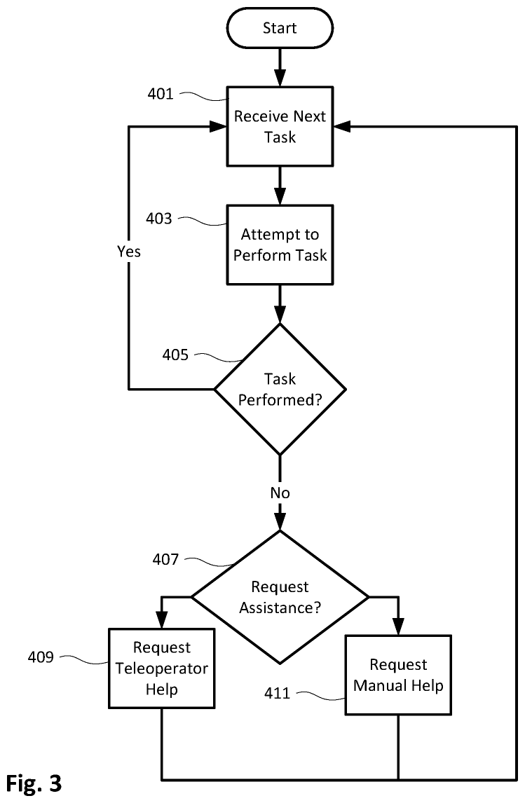

FIG. 3 is a flow diagram illustrating the assistance request process for a robot, such as robot 111. As shown in block 401, the robot 111 may receive a task, such as a pick and place task from robot control system 101. As shown in step 403, the robot 111 may attempt to perform the received task. Attempting to perform a task may include the robot performing any action associated with completing the task and/or evaluating the likelihood in which the robot will be able to successfully perform the task.

Evaluating the likelihood of success may include monitoring data provided by the robot, such as sensor data, to the robot control system 101. For example, when assigned a picking task, the robot may utilize sensor data to evaluate the probability of successfully grasping a target item by explicitly or implicitly evaluating aspects of the sensor data including: (1) the location of the target item relative to the picking container; (2) the orientation of the picking item; and (3) the location of other items relative to the target item (e.g., are other items overlying the target item). In some instances, the robot control system 101 may periodically or continually evaluate the likelihood of success of the robot 111 in completing a task after providing the task to robot 111. In this regard, if the robot control system 101 determines that the robot 111 is unlikely to autonomously complete the task after one or several attempts, the robot control system or the robot can preemptively request assistance to avoid the failed attempts and improve efficiency.

In the event the robot control system 101 determines the robot 111 is unable or unlikely to complete the task, the robot control system 101 may select a new task to provide to the robot 111. Alternatively, the robot control system may request teleoperator or onsite assistance to assist the robot with completing the task. In some instances, the robot 111 may monitor its own sensor data to evaluate whether the robot is capable of, or likely to, complete the instructed task. In such examples, the robot 111 may send signals to the robot control system 101 that indicate the predicted probability of performing the task.

In some instances, when a task of a particular type is first assigned to a robot, or the robot has only infrequently performed the particular task, the robot control system may automatically request teleoperator assistance. The instructions received from the teleoperator and/or other data generated in completing the particular task may be collected and used to train a machine learning algorithm, as described further herein.

As shown in block 405, the robot control system 101 may determine whether the task was successfully completed by the robot 111. Successful completion of a task may be determined from sensor data. For instance, the robot control system 101 may monitor a video feed transmitted from the robot to monitor the progress of a task. In another example, the success of a task may be determined from other sensor data obtained from the sensor 118 of robot 111. For example, if the robot 111 is instructed to pick and pack a product using a suction-based end-effector, the sensor 118 may be a pressure sensor capable of characterizing if an object is blocking the suction path of the suction-based end effector. When an object is secured to the end effector, the sensor 118 of robot 111 characterizes the grasp as successful. On the other hand, if the picking arm of the robot attempts to remove a product from the picking container and the sensor determines that the hose is not obstructed, or the item is dropped before the robot control system 101 instructs the robot 111 to release the item, the robot control system will characterize the pick and place task as unsuccessful. In other instances, the robot 111 may evaluate through the sensor data and autonomously determine whether or not the task was successfully completed without the assistance of the robot control system 101.

When the task is completed, the robot 111 may perform its next assigned task, request a new task, or otherwise wait for a new task to be assigned. In the event the task is not completed, the robot control system 101 may request assistance, as illustrated in block 407.

When teleoperator assistance is required, robot control system 101 may send a help request to a teleoperator system, such as teleoperator system 121, as illustrated in block 409. On the other hand, when onsite assistance is required, the robot control system 101 may send a help request to an onsite operator system, such as onsite operator system 131, for manual assistance, as illustrated in block 411. Typically, assistance with pick and place tasks may be directed to a teleoperator system, and assistance with maintenance or blockages may be sent to an onsite operator system. However, the teleoperator system may be provided with maintenance or blockage requests, and the onsite operator system may receive requests for assistance with pick and place tasks. In instances when the robot 111 autonomously determines the task was not successfully completed, the robot 111 may directly communicate with one or more teleoperator or onsite operator systems to request assistance. Alternatively, or simultaneously, the robot 111 may inform the robot control system 101 that assistance is required.

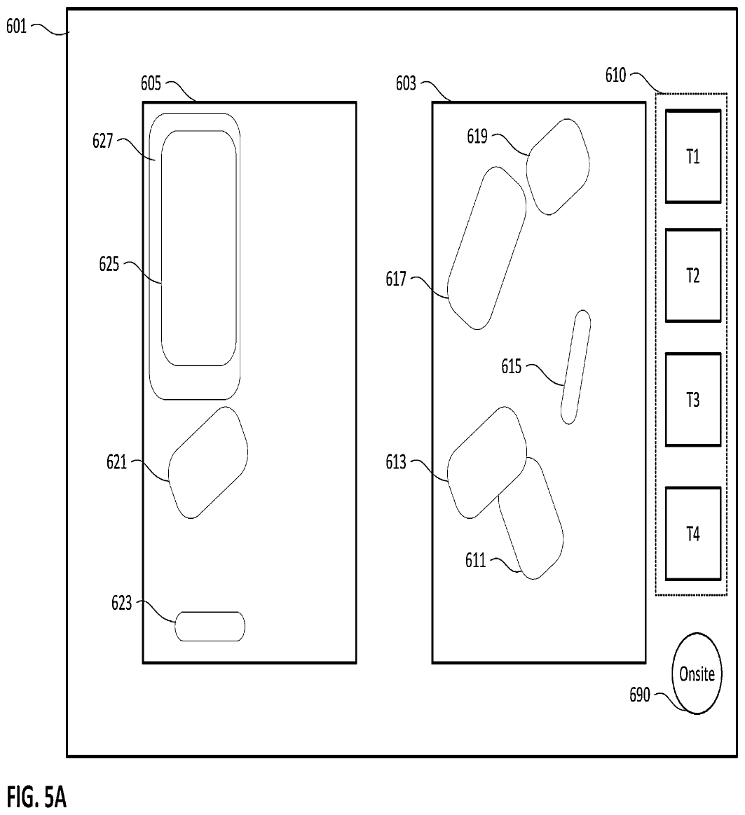

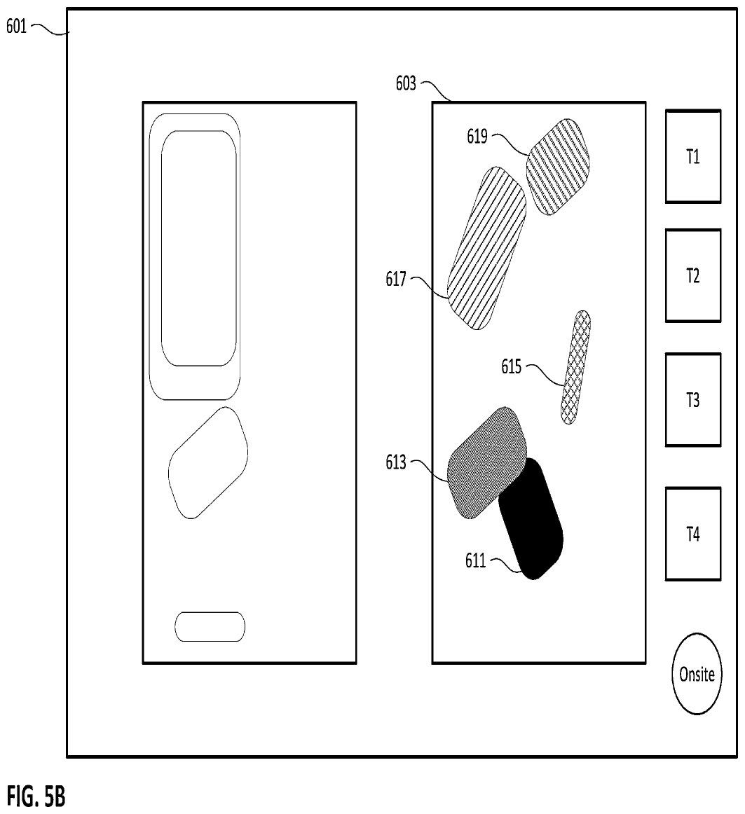

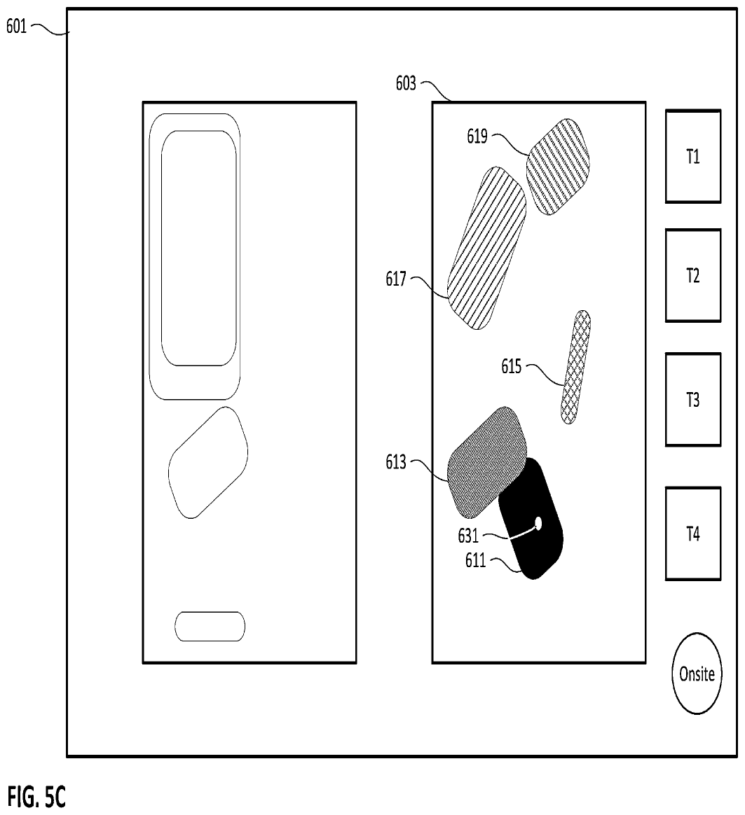

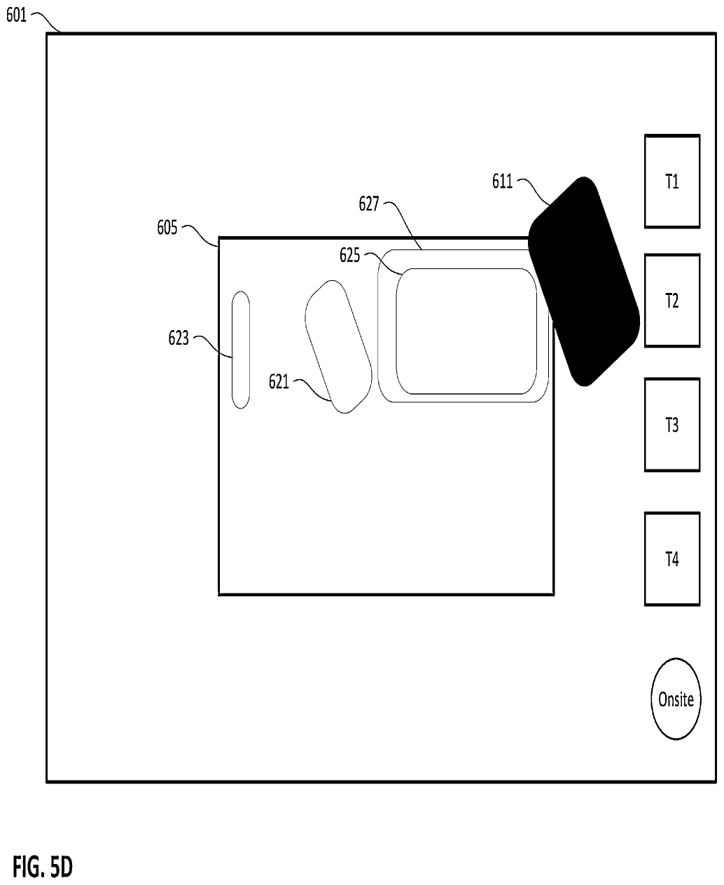

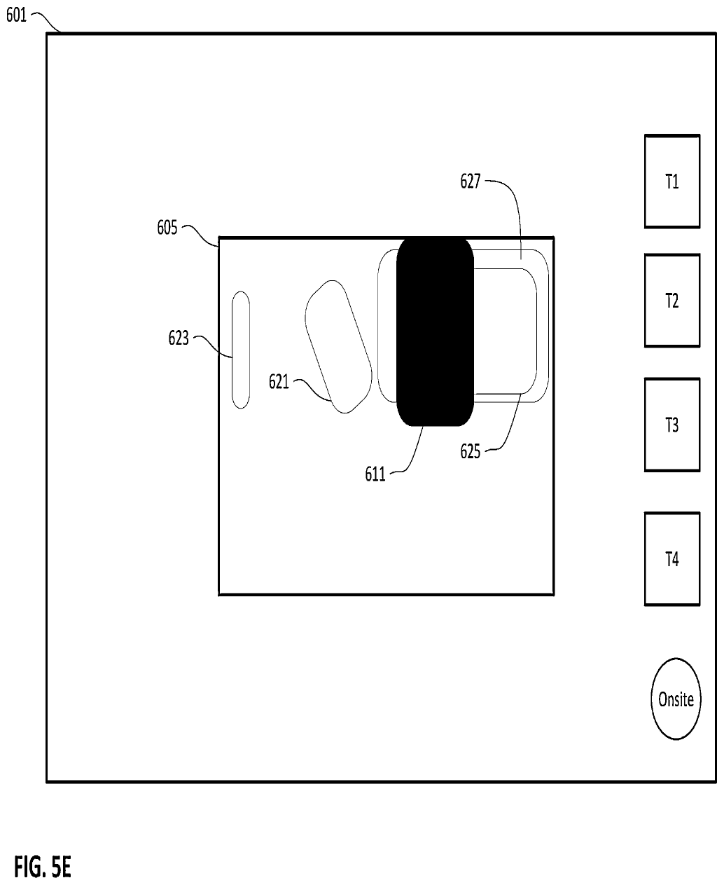

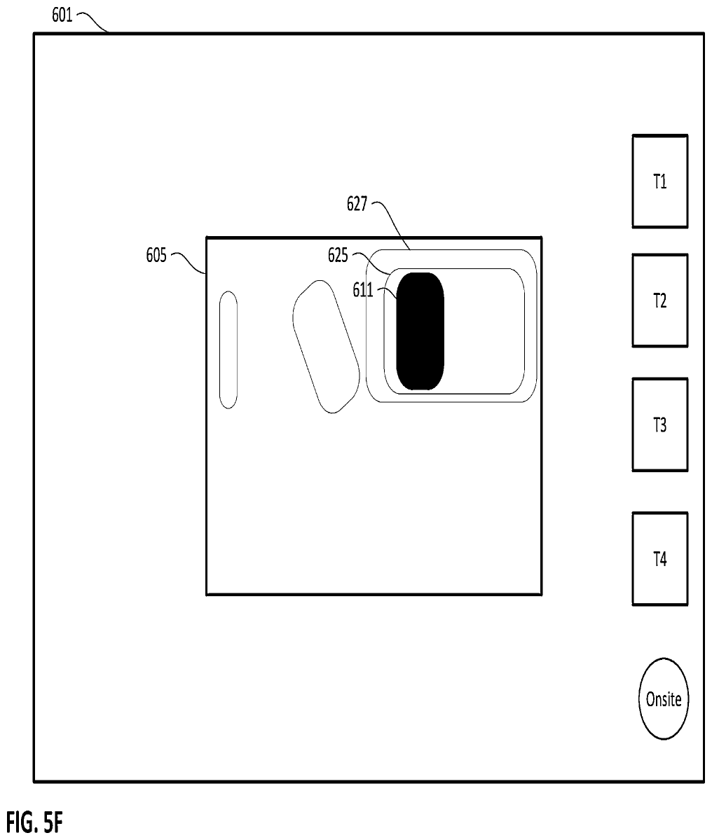

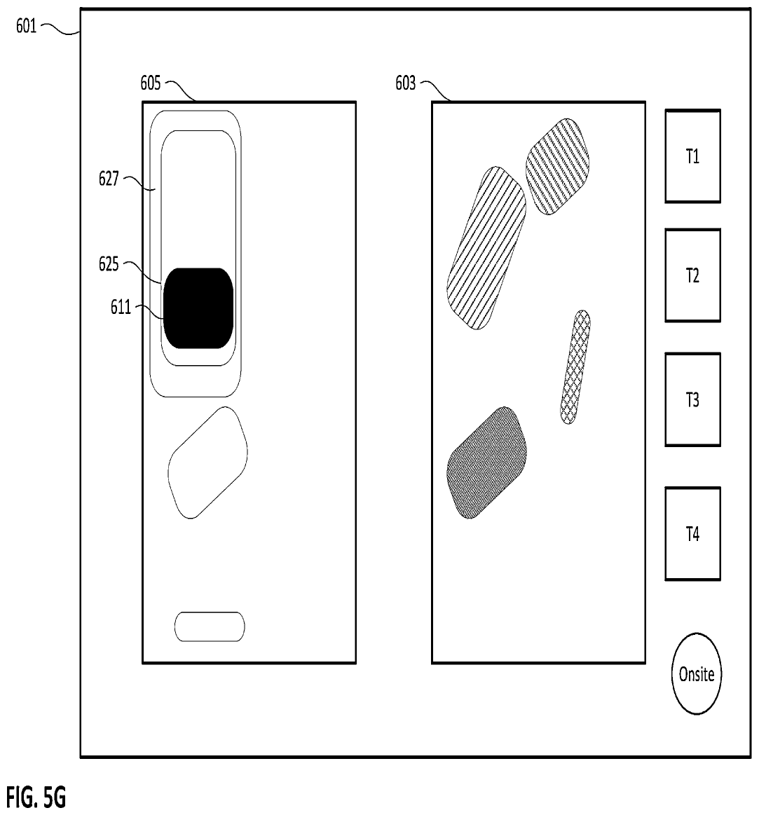

The teleoperator system 121 may include an option for requesting further assistance from an onsite operator. In this regard, if the teleoperator is unable to remotely assist a robot with a particular task, the teleoperator may request further assistance from an onsite operator, for example, by pressing a call button 690 within the interface 601, as shown in FIG. 5A. In this scenario, the teleoperator system 121 may send a request to an onsite operator system 131. Although not shown, call button 690 may be a physical button attached or otherwise connected to the teleoperator system.

In some instances, a broker, which may be part of system 100, may be tasked with ordering the assistance requests within a queue of the teleoperator system 121 and/or onsite operator system 131. The broker may run an algorithm to determine a “needs help score” to determine the priority of the queue, or the broker may connect a teleoperator control system directly to a particular robot based on the “needs help score” generated by the robot. The algorithm may be based on several factors, including the number of failed attempts, elapsed time from the start of the task, the level of task difficulty, the level of precision needed, the product/SK U to be manipulated, the task to be performed (e.g., picking and/or packing, auditing inventory, or correcting other errors) and the like.

The onsite operator system 131 may include an option for an onsite operator to directly report data to the robot, such as when clearing flags, performing tasks, etc. For example, a teleoperator may flag certain situations for onsite operators to address, such as an object blocking a path that a robot needs to traverse to complete a task, products falling out of the packaging, damaged products, objects that may be out of reach of the robot, and products nesting or otherwise getting stuck together (e.g., packaging tape of one object sticking to another object). Once the flagged situation is addressed by the onsite operator, the onsite operator may clear the flag with the onsite operator system 131. In some instances, the onsite operator system 131 may provide an option for an onsite operator to instruct a teleoperator that a robot or task may need to be monitored. The onsite operator system 131 may also have an option that opens up chat or phone call with vendor customer service staff to get near-instantaneous support.

In some instances, the onsite operator system 131 may report data to robot control system 101, or other device, such as storage device 150. The data may be stored in a database or other such data structure. The data may include statistics and performance tracking or issue requests, spare parts orders, feedback, etc. The database may also store data provided by sources, such as robot 111, robot control system 101, or teleoperator system 121. For example, the robot or robot control system may upload or otherwise forward the sensor data to the database.

Although only a single database is described, there may be multiple databases, collections of databases, etc. For instance, each device may have its own database where it uploads or otherwise forwards data. In other examples, each type of device may upload or forward data to a particular database. For example, all robots may upload data to a single database or a collection of individual databases.

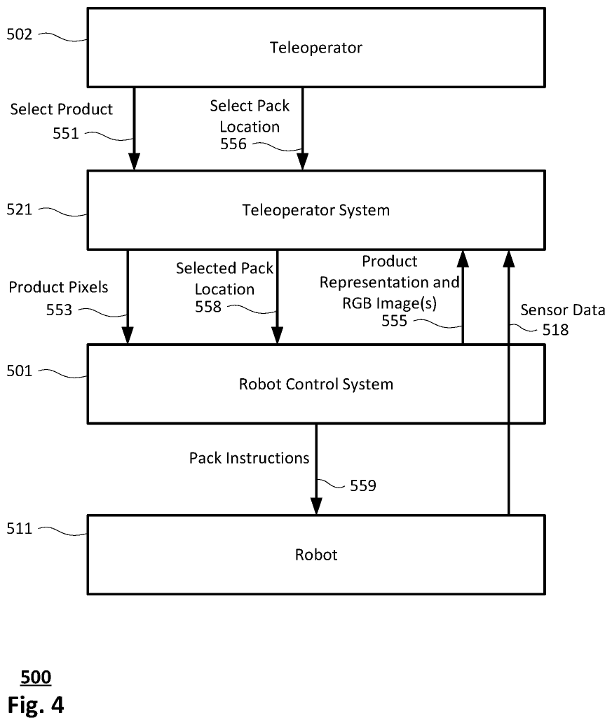

FIG. 4 is a flow diagram 500 illustrating the assistance process performed by a system during teleoperation of a robot by teleoperator 502 to perform a pick and pack operation. The pick and pack operation may include moving one or more products from a picking container to an order container. The systems illustrated in FIG. 4, including robot control system 501, robot 511, and teleoperator system 521 may be compared with the systems illustrated in FIG. 1, including robot control system 101, robot 111, and teleoperator system 121, respectively.

As shown in FIG. 4, teleoperator system 521 may receive sensor data 518 from the robot control system 501, which in turn may receive the sensor data from the robot 511, as illustrated by arrow 518. In some instances, the robot 511 may provide the sensor data directly to the teleoperator system 521. As described herein, sensor data 518 may include imagery provided by robot sensors, such as still and/or moving images of the robot and/or its environment, such as the picking container and order container, as well as the products contained within the respective containers.

The imagery may be output by the teleoperator system 521 via an interface on a display, or another such output device, for viewing by and/or interaction with the teleoperator 502. FIG. 5A illustrates an example interface 601 on a display of teleoperator system 521. As shown in FIG. 5A, the interface includes an image feed (e.g., a singular image, a series of images, or a video) provided by the robot sensors of robot 511. Robot 511 may provide the image feed directly to the teleoperator system 521, or the robot 511 may provide the image feed to the teleoperator system 521 via the robot control system 501. A s further shown in FIG. 5A, the image feed includes imagery of container 603 and order container 605. The image feed further includes imagery of the products within picking container 603 and order container 605, including products 611-619 in picking container 603 and products 621-625 in order container 605.

Interface 601 further includes an end effector selection section 610. End effector selection section 610 includes a collection of end effectors TI, T2, T3, and T4, which are available to the robot for performing a given task. Although four end effectors are shown in interface 601, the interface may display any number of end effectors, such as one, two, three, five, six, etc. The collection of end effectors shown in the interface 601 may change based on the end effectors available to the robot being controlled by the teleoperator system 521. For instance, if a robot has two available end effectors, interface 601 may display only those two available end effectors. In some instances, a teleoperator 502 may select any of the end effectors presented in the interface for the robot to use to perform a task. In some examples, the interface may prevent or recommend to the teleoperator 502 certain end effectors based on the capabilities of the end effectors to complete certain tasks. For instance, if a particular end effector is incapable of being used to complete a task currently assigned to robot 511, the interface 601 may not make the particular end effector available or may “gray out” the icon associated with that particular end effector. In another example, if a particular end effector is determined to be well suited for a particular task, the interface 601 may provide a visual indication indicating such. For instance, the icon corresponding to the well-suited end effector may be highlighted or bolded. In some instances, the well-suited end effector may automatically be selected to expedite the teleoperator intervention. Further, the interface 601 may provide a visual indicator to illustrate which end effector is currently in use or otherwise attached to the robot 511.

In some instances, the robot control system 501 may generate instance segmentation masks for the products within the container and/or order container. The instance segmentation masks may be a visual indicator, for example, a semi-transparent colored polygon, overlaid on some or all of the products within the picking container 603 and/or order container 605 to provide to the teleoperator 512 with distinct visual indications of the boundaries, size, and/or locations of products within the containers. Instance segmentation masks may be generated using machine learning models, such as a Mask Regional Convolutional Neural Network (MASK R-CNN). The masking may differentiate and distinguish one product from another. For example, a mask may be applied over items in a picking container to provide distinct visual indications for each product. Although the foregoing example describes the instance segmentation masks being generated by a robot control system, instance segmentation masks may be generated by systems other than the robot control system 501. For example, instance segmentation masks may be generated by a teleoperator system, onsite operator system, robot, broker system, image processing system, and/or any other system.

By applying masks to items in a picking container, a teleoperator may be more easily able to distinguish one product from another, even when the interior of the picking container is dark and/or multiple products are overlapping in the bin. Instance segmentation masks or other visual features can also be used to monitor the operation of a system, such as system 100. In this regard, the instance segmentation masks may provide a visual indication of the predictions being made by a machine learning algorithm, which in turn can be evaluated to determine if the machine learning algorithms are outputting correct and/or accurate predictions.

FIG. 5B shows instance segmentation masks generated by robot control system 501 overlaid on the products within the picking container 603. In this regard, the robot control system 501, or a system other than the robot control system, may combine the instance segmentation masks with the sensor data such that when the combined data is displayed by the teleoperator system 521, the instance segmentation masks are overlaid on the sensor data. In another example, the robot control system 501, or a system other than the robot control system, may transmit both the instance segmentation masks and the sensor data as discrete sets of data to the teleoperator system 521. In such a scenario, the teleoperator system 521 may control the display of the sensor data and instance segmentation masks. For instance, the teleoperator system 521 may display only the sensor data, only the instance segmentation masks, and/or the instance segmentation mask overlaid on the sensor data.

As shown in FIG. 5B, the instance segmentation masks on products 611-619 include various shading covering the entirety of the products in the container 603. However, in some instances, the instance segmentations masks may be different colors, highlighting, patterns, opacities, shadings, etc., or a combination thereof. In some instances, the instance segmentations may be presented merely as outlined boundaries of the products. In other examples, instance segmentations may cover only a surface or portion of a surface of some or all products, as opposed to the entirety of each product. In some examples, an instance segmentation mask may be applied to only the product, which is the focus of an assigned task.

To perform a teleoperated pick and place task, the teleoperator 502 may select a product to be picked from within the imagery displayed within the interface on the teleoperator system 521, as illustrated by arrow 551. The selection by the teleoperator 502 may be provided to the teleoperator system 521 via an input device, such as a mouse, keyboard, touchscreen, buttons, etc. The technique used to select a product may be dependent upon whether an instance segmentation mask is provided to the teleoperator system 521. In this regard, when the products within a container are presented with an instance segmentation mask, the teleoperator 502 may select a product to be picked by clicking, or otherwise selecting, any portion of a product covered by an instance segmentation mask. For example, the task assigned by the robot control system 501 to robot 511 may be to pick and place product 611 from picking container 603 to order container 605. As shown in FIG. 5C, teleoperator system 521 may provide an instance segmentation mask over the products in picking container 603, including product 611. The teleoperator 502 may select a point, such as point 631, within the instance segmentation mask covering product 611.

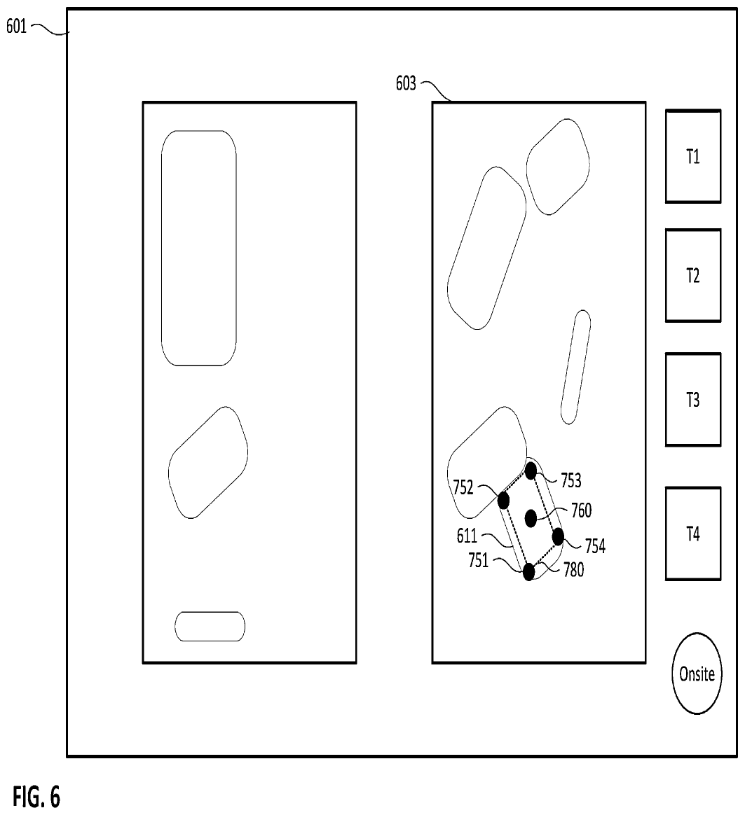

In instances where the teleoperator system 521 is not provided with instance segmentation masks or the teleoperator 502 is not satisfied with the presented instance segmentation masks, the teleoperator 502 may manually create an instance segmentation mask and then select a product by selecting a number of points on the product to be picked. For instance, and as illustrated in FIG. 6, a teleoperator may select five points, including 751-754 and 760, on product 611. Selected points 751-754, referred to herein as boundary points, may correspond to the polygonal boundary of product 611. Selected point 760 may correspond to the manipulation point on the product 611. The manipulation point may be the location on the product where an end effector of a robot is instructed to pick the product, referred to herein as a “grasping point” or “grasping location.” Alternatively, the manipulation point may be any other point, area, surface, axis, feature, virtual feature, etc., that assists in defining how an object should be manipulated. For example, the manipulation point may include a virtual feature such as a virtual axis to rotate the product or other object around. Although FIG. 4 illustrates a selection of a manipulation point (selected point 760) by a teleoperator, in some instances, the manipulation point may be automatically selected by the robot 511, robot control system, or another device.

After a product is selected, the teleoperator system 521 may determine the pixels corresponding to the selected product. In this regard, when a product is selected with an instance segmentation mask, the pixels corresponding to the selected product may be the same pixels as the instance segmentation mask of the product. When a product is selected by a teleoperator selecting boundary points, the system may calculate the selected pixels as those being with an area defined by the boundary points, such as area 780 defined by boundary points 751-754 shown in FIG. 6. Although FIG. 6 illustrates a teleoperator selecting four boundary points 751-754, a teleoperator may select any three or more boundary points. For example, a teleoperator may select three boundary points, and the area defined by the three boundary points may be a triangle. Referring again to FIG. 4, the determined pixels corresponding to the selected product may be sent by the teleoperator system 521 to the robot control system 501, as shown by arrow 553.

The robot control system 501 may combine the determined pixels with RGB and depth images provided within the sensor data provided by robot 511. By combining the determined pixels with the depth and RGB images of the order container on a per-pixel basis, the robot control system may augment the determined pixels with depth information, thereby generating a RGB-D height map representation of the product and other objects that may be contained in the RGB and depth images, such as the order container and end effector of the robot 511. The height map may provide a spatially consistent orthogonal projection of the item being picked relative to the location the item is being placed. In this regard, the height map representation of the product illustrates the representation of the product on the same relative scale as the order container and any other products or objects included in the RGB and depth images. By doing such, a teleoperator may be provided with a realistic view of the product that can be relied upon to prevent the product from clipping the edges of other items or being placed imprecisely in the order container due to the scale of the object being bigger and/or smaller depending on their relative position to the camera.

The representation of the product and the RGB images may be provided to the teleoperator system 521, as illustrated by arrow 555 in FIG. 4. By presenting the product and order container on the same scale, such as by displaying the height map representation, a teleoperator may be able to position the product within the order container. For example, and as illustrated in FIGS. 5D, 5E, and 5F, an RGB image of the order container 605 and the products contained therein, including products 621-625, as well as the representation of the product 611 are displayed on the interface 605. Although FIGS. 5D, 5E, and 5F illustrate the order container 605 and the products therein as being rotated relative to the position of the order container 605 in FIGS. 5A-5C, the position of order container 605 and the products contained therein may be in any position. As further shown in FIG. 5D, the product representation 611 may be initially presented in a starting position on the interface 601. As the product representation 611 is positioned above the order container 605, the size of the product representation 611 appears larger than when the product representation 611 was within the picking container 603, as shown in FIG. 5C.

Referring again to FIG. 4, the teleoperator 502 may select a pack location within the order container via the teleoperator system 521, as illustrated by arrow 556. In this regard, the teleoperator 502 may interact with the teleoperator system 521 to rotate, move, and or otherwise position the product representation within the order container 605. As explained herein, interaction with the teleoperator system 521 by the teleoperator 502 may be done via an input device, such as a mouse, keyboard, touchscreen, etc.

For example, and as illustrated in FIG. 5E, the product representation 611 was moved from the starting position illustrated in FIG. 5D, and further rotated relative to the other products in the order container, such that the product representation 611 is positioned on top of product 625.

As illustrated in FIG. 5F, the teleoperator may position the product representation 611 within the order container 601. As the product representation 611 is moved deeper within the order container 601, the size of the product representation is scaled accordingly. In this regard, the further the product representation 611 is moved into the order container 601 the smaller it becomes. Depending on the capabilities of the depth camera used to create the RGB-D height map, the representation of the product may be accurate up to the resolution of 0.001 m. Thus, the teleoperator may select a pack position with similar accuracy. Such accuracy provides the teleoperator with the ability to more densely pack order containers than was previously possible.

Once a final pack location is determined by the teleoperator 502, the teleoperator may provide an input confirming the pack location to the teleoperator system, such as by selecting a button on the display or providing another input, such as “double-tapping” the screen.

In some instances, such as when the teleoperator is not viewing the height map representation, the teleoperator system 521 or robot control system 501 may adjust or scale the representation of the product based on the depth data corresponding to the location of an input, such as a cursor, within the interface 601. For example, the teleoperator may manipulate a cursor within an interface 601 when selecting a packing location within an order bin. As the teleoperator moves the cursor to different areas of the scene with different corresponding levels of depth within the order bin (as occurs when the cursor is positioned over underlying items of varying height), the representation of the product may automatically be adjusted or otherwise scaled according to the depth data and the relative position of the cursor compared to the position of the sensor providing the sensor data. For example, the product representation may be scaled smaller when the cursor is positioned deeper in order bin (i.e., further from the position of the sensor capturing the sensor data), and the product representation may be larger when the cursor is positioned closer to the top of the order bin (i.e., closer to the position of the sensor capturing the sensor data). By scaling the product representation based on the location of the input, a teleoperator may be provided with a visualization that mimics depth perspective and what the product corresponding to the product representation would look like, from the view of the sensor of robot 511 or another virtual viewpoint.

The selected pack location may be sent from the teleoperator system 521 to the robot control system 501, as illustrated by arrow 558 in FIG. 4. The robot control system 501 may determine control instructions for the robot 511 that will cause the robot to pack the product into the order container 605 in the selected pack location. The robot control system may then send the control instructions to the robot 511, which in turn may autonomously pack the product in accordance with the received control instructions. As such, other than providing one or more short inputs, the teleoperator does not need to guide the robot through the entire pick and place operation, thereby increasing teleoperation efficiency and reducing duplicative efforts between the robot, robot control system, and teleoperator. Although not shown, a neural network or other such algorithms may be used to determine the pack location of the object. In this scenario, the teleoperator may not be required to provide the pack location and/or may be asked to confirm the pack location.

Moreover, the instance segmentation mask can be used to calculate the orientation of the product when it is in the order container and/or after it is grasped. In this regard, the orientation may be determined by using estimations of height from where the product is positioned in the order container or from an item master which provides dimensions of the object. From the two-dimensional instance segmentation mask, two out of the three dimensions can be predicted by matching the length/width or principal axes of the mask with the closest two of the three dimensions in the item master for that object. The third dimension being based on the first two dimensions. From these determinations, the relative pose and size of the object can be determined which can be used to determine pack poses in the order bin.

As illustrated in FIG. 5G, after the teleoperator 502 provides a pack location to the teleoperator system 521, the interface 601 of the teleoperator system 521 may return to show the sensor data received from the robot 511 and to receive further instructions from the teleoperator.

FIG. 5G further shows that product 611 was successfully placed in the selected pack location.

Although FIG. 4 illustrates the teleoperator providing both pick and place instructions, the teleoperator may provide one or the other. For instance, a robot may require teleoperator assistance after picking a product. In this scenario, the teleoperator may provide only place instructions, such as selecting a pack location.

The control instructions, product selection (i.e., selection of product boundary points and/or a grasping location, grasping location on an object mask, etc.) selected pack location, and other data generated during the teleoperation of a robot may be captured, recorded, and stored in the robot control system 121 and/or storage device 150. The robot control system, or another such computing device, may process the collected data to train a machine learning algorithm, such as neural network 108 shown in FIG. 1. In this regard, the machine learning algorithm may be trained from the data, such as labeled data, generated during the teleoperation of robots to accomplish a variety of tasks in various environments and applications. Labeled data may include data generated in response to an input from a teleoperator. For example, labeled data may include a grasping label that indicates a grasping location selected by a teleoperator for a product. In another example, labeled data may include a packing label that indicates a pose and/or location within an order bin to place a product selected by a teleoperator. The labeled data may be used to train the machine learning algorithm using supervised, semi-supervised, self-supervised, or a combination thereof learning methods. After training, data can be presented to the machine-learning model, and a prediction can be generated.

The trained machine learning algorithm may be used by the robot control system 101 to predict future autonomous control instructions for robots 111 that result in more densely packed containers, better selection of manipulation points, such as grasping locations, etc. Although FIG. 1 illustrates a neural network, any type of machine learning model may be used.

As outlined above, the components of system 100, including robot control system 101, teleoperator system 121, and onsite operator system 131 may be used to perform other tasks in addition to or alternatively from pick and place tasks. For example, the components of system 100 may be used in manufacturing applications to assist in the fabrication of parts and/or products (“objects”) and to assist in assembling or joining of objects.

For instance, the teleoperator system 121 may provide an interface on which a teleoperator may manipulate one or more objects, such as by selecting two faces on two objects to be mated together. In this regard, the interface may provide a computer-aided design (CAD) type interface through which the teleoperator may interact with visual representations of the objects to be assembled or manufactured.

The visual representations may include CAD models of the objects being assembled or manufactured, RGB-D images received from sensors, point clouds of the objects generated from the RGB-D images, and/or CAD models overlaid onto point clouds generated from sensor data, such as data provided by sensor(s) 118. In instances where CAD models are overlaid onto point clouds, a computer vision model may align the surfaces of the CA D models with the corresponding locations on the point clouds using 5D pose estimation of the objects determined from the RGB-D images provided by the sensors. 5D pose estimation includes estimates of the location and poses of the objects. Although the examples described herein describe overlaying multiple CAD models over corresponding objects, the visual representation may include just a single CAD model overlaid on a point cloud corresponding to a single object. As used herein, CAD models include any digital model including, but not limited to models in STEP, STL, OBJ, IGES, IGS and other such formats.

By overlaying CAD models onto a point cloud, manipulation of the objects is more intuitive for a teleoperator, as the teleoperator is provided a complete illustration of the objects within the teleoperator system 121 (or other device), as CAD models. In this regard, point clouds may have occlusions based on where the sensors capturing the RGB-D data are located. For instance, sensors capturing RGB-D data of the top, sides, and front of an object may not capture RGB-D data of the bottom of a rectangular object. As such, the point cloud generated from the RGB-D data may not include the bottom of the rectangular object. Similarly, other objects may occlude the sensors from capturing portions of an object, resulting in missing point cloud data for that object. However, as long as the point cloud includes enough information to enable a 5D pose estimation to be made, a CAD model of an object may be overlaid on the point cloud, thereby giving the teleoperator a full visualization of the object.

The teleoperator can select features of the objects, such as planes, surfaces, axes, holes, hole patterns, etc., that can be physically present or augmented, virtually into the CAD-like interface (e.g., virtual planes, axes, etc.) These features may be defined in the CAD model of the object. The teleoperator may use the features to help with the assembly, manufacturing, and manipulation of objects. In some instances, the interface may highlight these features for the teleoperator or appear when the cursor hovers over areas of the CAD model corresponding to the features.

Continuing the example of mating two parts together, the teleoperator may manipulate CAD models of the two parts overlaid on corresponding point clouds of the two parts to position the two parts as desired and select the faces and/or locations that are to be mated together. In another example, the teleoperator may interact with representations of a screw and a product having a tapped hole into which the screw is to be inserted. The teleoperator may select axes that could be made coincident, faces that should be made flush, or other assembly instructions that align and help fasten or assemble parts. For example, the teleoperator may align the representation of the two parts to be mated together and provide high-level instructions directing the robot 111 to mate selected faces of the two parts together. The robot control system 101 (or robot 111) may then generate low-level instructions for execution by robot 111 that cause the robot to mate the two selected faces together. The low-level instructions may include a grasp and/or motion plan that positions the parts consistent with the positions of the CAD representations of the parts within the CAD interface and mating the selected faces together without collisions

In another example, the teleoperator may interact with CAD representations of a screw and a product having a tapped hole into which the screw is to be inserted. The teleoperator may align the representation of the screw with the tapped hole (or vice versa) and provide an instruction directing the robot 111 to insert the screw into the tapped hole. The robot control system 101 (or robot 111) may then generate low-level instructions for execution by robot 111 that cause the robot to move the screw into alignment with the tapped hole and insert the screw into the tapped hole.

The components of system 100 may additionally be used to complete farming tasks, such as harvesting, cultivation, etc. When completing a farming task, the teleoperator system 121 may provide an interface on which a teleoperator may select a branch to prune or fruit to pick off of the branch. The robot control system 101 may then generate instructions for execution by a robot 111 that cause the robot to prune the selected branch or pick the selected fruit.

Although the technology herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

1. A method for providing pick and place instructions to a robot, the method comprising:
outputting, by the one or more processors, sensor data, the sensor data including an image feed of a picking container in which at least one product is located;
receiving, by the one or more processors, an input indicating a selected product, the selected product being one of the at least one products located in the picking container;
outputting for display, by the one or more processors, a representation of the selected product and at least one image of an order container, the representation of the product being scaled relative to the at least one image of the order container;
receiving, by the one or more processors, a place input, the place input corresponding to positioning the representation of the product at a packing location within the at least one image of the order container;
transmitting, by the one or more processors, the packing location to a robot control system.
